(19) United States
(12) Patent Application Publication
(10) Pub. No.: US 2011/0246504 A1
(43) Pub. Date: Oct. 6, 2011

(54) SYSTEM, METHOD AND COMPUTER PROGRAM PRODUCT FOR PERFORMING ONE OR MORE ACTIONS BASED ON A COMPARISON OF DATA ASSOCIATED WITH A CLIENT TO ONE OR MORE CRITERIA

(75) Inventors: Steve Slater, Alamo, CA (US); Brendan O'Connor, San Francisco, CA (US)

(73) Assignee: SALESFORCE.COM, INC., San Francisco, CA (US)

(21) Appl. No.: 12/942,926

(22) Filed: Nov. 9, 2010

Related U.S. Application Data
(60) Provisional application No. 61/320,193, filed on Apr. 1, 2010.

(51) Int. Cl. G06F 17/30

(52) U.S. Cl. 707/769; 707/E17.014

(57) ABSTRACT

In accordance with embodiments, there are provided mechanisms and methods for performing one or more actions based on a comparison of data associated with a client to one or more criteria. These mechanisms and methods for performing one or more actions based on a comparison of data associated with a client to one or more criteria can enable improved data collection and analysis, enhanced client knowledge of a system, etc.

### CLAIM OF PRIORITY

This application claims the benefit of U.S. Provisional Patent Application 61/320,193, entitled “Method and system for performing security health checks in an on-demand service environment,” by Steve Slater, filed Apr. 1, 2010 (Attorney Docket No. SFC1P108+/296PROV), the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE INVENTION

One or more implementations relate generally to analyzing system data, and more particularly to performing one or more actions based on the analysis of system data.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

In conventional systems, it may be desirable to analyze and optimize one or more elements present in a system. For example, an entity may desire an optimized security configuration within their system, based on their particular customer information. Unfortunately, conventional analysis and optimization systems have been associated with various limitations.

Just by way of example, traditional methods of analyzing and optimizing one or more elements present in a system may involve collecting a large volume of different types of data within a system. The volume and diversity of this system data may make data collection and analysis prohibitive for an entity. Further, the entity may be unfamiliar with the system and/or optimizations recommended for the system. Accordingly, it is desirable to provide techniques that simplify data collection and analysis.

### BRIEF SUMMARY

In accordance with embodiments, there are provided mechanisms and methods for performing one or more actions based on a comparison of data associated with a client to one or more criteria. These mechanisms and methods for performing one or more actions based on a comparison of data associated with a client to one or more criteria can enable improved data collection and analysis, enhanced client knowledge of a system, etc.

In an embodiment and by way of example, a method for performing one or more actions based on a comparison of data associated with a client to one or more criteria is provided. In one embodiment, data associated with a client of a multi-tenant on-demand database system is retrieved. Additionally, the data is compared to one or more criteria. Further, one or more actions are performed, based on the comparing.

While one or more implementations and techniques are described with reference to an embodiment in which performing one or more actions based on a comparison of data associated with a client to one or more criteria is implemented in a system having an application server providing a front end for an on-demand database system capable of supporting multiple tenants, the one or more implementations and techniques are not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 illustrates a method for performing one or more actions based on a comparison of data associated with a client to one or more criteria, in accordance with one embodiment;

FIG. 2 illustrates a method for performing a security health check of a multi-tenant on-demand database system, in accordance with another embodiment;

FIG. 3 illustrates an exemplary graphical health summary, in accordance with yet another embodiment;

FIG. 4 illustrates an exemplary security configuration settings page, in accordance with one embodiment;

FIG. 5 illustrates an exemplary user and administration information page, in accordance with one embodiment;

FIG. 6 illustrates an exemplary sharing analysis page, in accordance with one embodiment;

FIG. 7 illustrates a saved security health check summary, in accordance with one embodiment;

FIG. 8 illustrates a privileged users detail page, in accordance with one embodiment;

FIG. 9 illustrates a full profile analysis page, in accordance with one embodiment;

FIG. 10 illustrates a block diagram of an example of an environment wherein an on-demand database system might be used; and

FIG. 11 illustrates a block diagram of an embodiment of elements of FIG. 10 and various possible interconnections between these elements.

### DETAILED DESCRIPTION

### General Overview

Systems and methods are provided for performing one or more actions based on a comparison of data associated with a client to one or more criteria.

As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers.

Next, mechanisms and methods for performing one or more actions based on a comparison of data associated with a client to one or more criteria will be described with reference to example embodiments.

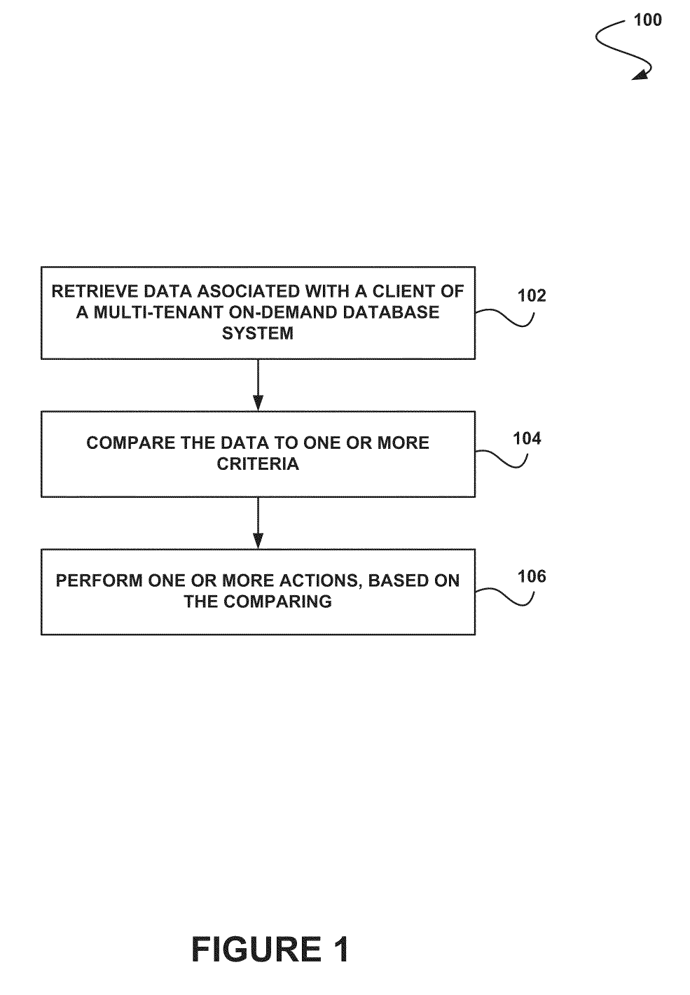

FIG. 1 illustrates a method 100 for performing one or more actions based on a comparison of data associated with a client to one or more criteria, in accordance with one embodiment. As shown in operation 102, data associated with a client of a multi-tenant on-demand database system is retrieved. In one embodiment, the client may include a customer of the multi-tenant on-demand database system (e.g., a larger enterprise customer, a small independent customer, etc.), a user of the multi-tenant on-demand database system, etc. For example, the client may include a customer that has one or more organizations within the system.

In another embodiment, the data associated with the client may include one or more items of metadata. In another embodiment, the data may include settings associated with a security configuration of the client on the system. For example, the data may include one or more of password settings, session settings, login settings, authorization settings, sharing settings, etc. In yet another embodiment, the data may include client data found within the system. For example, the data may include data within an organization of the client within the system.

Additionally, in one embodiment, the data associated with the client may include statistical data of the client within the system. For example, the data may include a number of profiles created by the client, a number of users created by the client, a number of administrators allowed by the client, a ratio of administrators to users within the client organization of the system, etc. Further, in another embodiment, the data associated with the client may include data associated with usage of system resources by the client. For example, the data may include bandwidth used by the client over a predetermined period of time, storage space used by the client, etc.

In yet another embodiment, the data may include data associated with marketing performed by the client. Of course, however, the data may include any data that may be associated with the client on the multi-tenant on-demand database system. In this way, the data associated with the client may illustrate a current configuration (e.g., a security configuration, a network configuration, a usage configuration, role configuration, etc.) of the client within the multi-tenant on-demand database system.

Further still, in one embodiment, the data may be retrieved by querying one or more portions of the system (e.g., one or more system monitors, etc.). In another embodiment, the data may be retrieved by accessing one or more data storage locations within the system. In yet another embodiment, the data may be retrieved in response to a request by the client. In still another embodiment, the data may be retrieved at a predetermined time interval. Of course, however, the data may be retrieved in any manner.

It should be noted that, as described above, such multi-tenant on-demand database system may include any service that relies on a database system that is accessible over a network, in which various elements of hardware and software of the database system may be shared by one or more customers (e.g. tenants). For instance, a given application server may simultaneously process requests for a great number of customers, and a given database table may store rows for a potentially much greater number of customers. Various examples of such a multi-tenant on-demand database system will be set forth in the context of different embodiments that will be described during reference to subsequent figures.

Further, as shown in operation 104, the data is compared to one or more criteria. In one embodiment, the criteria may include a predetermined configuration for the client on the system (e.g., a default configuration, an optimized configuration, etc.). For example, the criteria may include optimization criteria that are calculated based on characteristics of the client within the system. In another example, the criteria may be associated with client compliance to a system policy. For example, the criteria may include security best practices that are determined for the client by the system (e.g., the most secure configuration of a client using the system, etc). In this way, the criteria may act as a baseline for comparison to the retrieved data.

Additionally, in one embodiment, comparing the data to one or more criteria may include determining a deviation of the data from the one or more criteria. For example, one or more differences may be determined between the data and the criteria, and the magnitude of these differences may be calculated. In this way, it may be determined how much the data deviates from the predetermined baseline. In another embodiment, the comparison may be performed using an algorithm/formula. For example, the data may be input into a particular algorithm that compares the data to the criteria. Of course, however, the comparison may be performed in any manner.

Further, in another embodiment, one or more elements of the data may be weighted. For example, elements of the data that are determined to be more/less important than other elements may be weighted more/less heavily than those elements during the comparing, respectively (e.g., by altering configurable metadata within the system, etc.). In yet another embodiment, the elements to be weighted (along with the amount of weighting) may be determined by an administrator of the system. In still another embodiment, the elements to be weighted (along with the amount of weighting) may be determined by the client. For example, the client may determine elements of the data that are more important to the client, which may then be given a greater weight during the comparing.

Further still, in one embodiment, comparing the data to the one or more criteria may be performed utilizing a program (e.g., a program that includes one or more algorithms, etc.). For example, the program may be part of another application of the system (e.g., a compliance portion of an existing application, etc.), may be a separate application (e.g., a standalone compliance application, etc.), etc. In another embodiment, comparing the data to the one or more criteria may be performed according to a template. For example, the template may include particular weighting factors and algorithms to be used during the comparing. In another example, the template may be specific to the client (e.g., may account for one or more particular issues deemed important by the client, etc.). In another embodiment, multiple templates may be provided, and the client, administrator, or other entity may determine which template is to be used during the comparing. In yet another embodiment, the results of comparing the data and the criteria may be saved. For example, the results may be saved as a particular checkpoint.

Also, as shown in operation 106, one or more actions are performed, based on the comparing. In one embodiment, the results of the comparing may be presented to the client of the multi-tenant on-demand database system. For example, an overall summary, report card, etc. may be output to the client that illustrates the differences between the retrieved data and the one or more criteria. In another example, the magnitude of these differences may be presented to the client. For instance, an overall security summary may be provided to a customer of the system that illustrates how various security elements in the system that are associated with the customer compare to recommended security settings provided by the system, system administrator, etc. In this way, the client may be able to ascertain whether the current configuration of their data is in line with the criteria recommended by the system, administrator, etc.

In another embodiment, the results of the comparing may include a numeric score. For example, the results may include a score from 0 to 100, based on the similarity between the data and the one or more criteria (e.g., the more similar the data and the criteria are, the closer to 100 the score is, etc.). In yet another embodiment, the results of the comparing may include a color indicator. For example, the results may include a red, yellow, or green indicator based on the similarity between the data and the one or more criteria (e.g., green for sufficiently similar, and therefore following recommended criteria; yellow for significant differences, and therefore needing improvement to follow recommended criteria; and red for many differences, and therefore needing much alteration in order to follow the recommended criteria, etc.). In yet another embodiment, the results may include a pass or fail indication. For example, the results may indicate whether the security settings associated with the client pass or fail the recommended requirements for the system.

Additionally, in one embodiment, one or more recommendations may be provided to the client, based on the comparing. For example, recommendations may be provided to the client as to how to adjust or otherwise alter the data associated with the client in order to better comply with the one or more criteria, based on the comparing. In another example, the recommendations may be provided to the client in the form of links (e.g. links to help documentation, training documentation, system setting adjustment pages, etc).

In another embodiment, the links may be dynamically determined based on the comparison of the data and criteria. For example, if it is determined that the sharing settings of the client are less restricted than the sharing settings recommended by the system, a link may be dynamically provided to documentation regarding how to adjust the sharing settings, as well as best practices documentation with respect to sharing settings. In this way, the client may be able to learn more about any inefficiency associated with their current system configuration, and may be able to determine how to change such configuration in order to come into alignment with recommended best practices for their configuration.

Further, in one embodiment, the client may be able to adjust one or more criteria, based on the comparing. For example, the client may weight one or more of the criteria more or less heavily in order to alter future comparing (e.g., in order to comply with a client policy, preference, etc.). In another embodiment, the results of the comparing may be sent to one or more entities. For example, the results of the comparing may be sent via electronic mail message to a security officer of the system, an administrator of the system, or any other entity.

In another embodiment, the client may be able to adjust one or more settings associated with the data, based on the comparing. For example, the client may be able to change one or more system settings in order to obtain better results during later comparisons. In another embodiment, the client may allow one or more system settings to be altered. For example, the client may allow data to be altered in accordance with one or more suggested settings provided by the system (e.g., by selecting a recommended settings option, etc.).

Also, in one embodiment, comparisons may be tracked over time. For example, previous comparisons of the data and criteria from earlier time periods may be retrieved, and displayed to the client in addition to the current comparison (e.g., as a chart illustrating the progress of the comparison over time, etc.). Additionally, in another embodiment, permission to access one or more resources may be conditionally enabled based on the comparing. For example, access to one or more data elements within the system may be enabled if the data do not deviate from the one or more criteria by a predetermined amount.

In this way, the client may be given a high level view of how data associated with the client compares to the one or more criteria. For example, the client may be given a high level security view of how the client is using system services. Additionally, this may enable a client that is unfamiliar with one or more details of the system (e.g., settings, etc.) to comply with the criteria. For example, a client that is not familiar with individual system security settings may be able to receive a secure system configuration and overall security summary without the appropriate knowledge of security implementation in the system. Further,

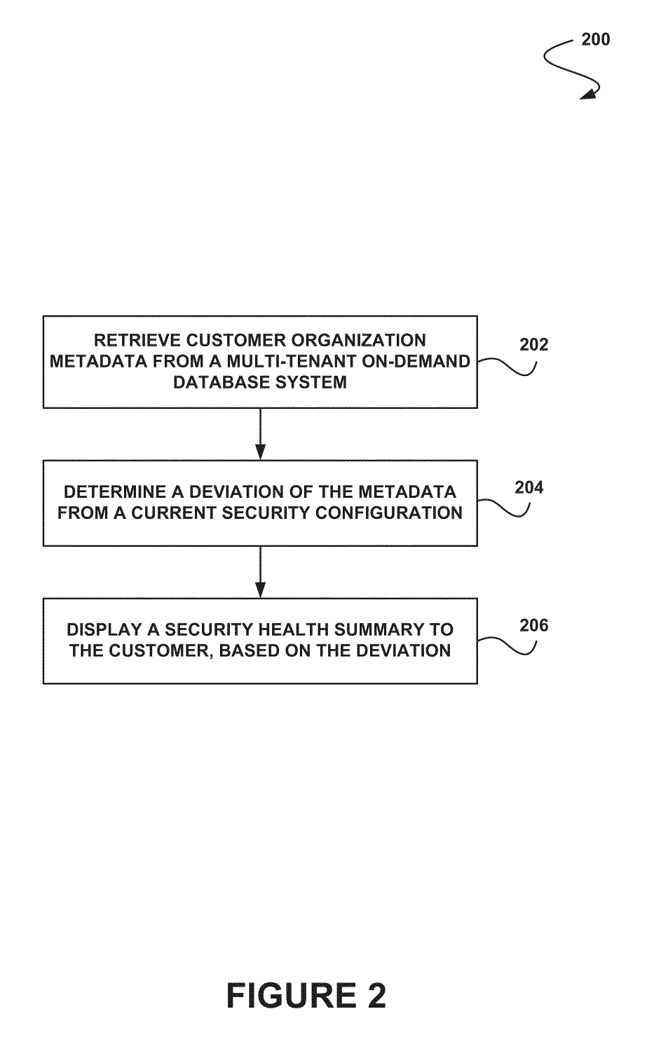

FIG. 2 illustrates a method 200 for performing a security health check of a multi-tenant on-demand database system, in accordance with another embodiment. As an option, the present method 200 may be carried out in the context of the functionality of FIG. 1. Of course, however, the method 200 may be carried out in any desired environment. The aforementioned definitions may apply during the present description.

As shown in operation 202, customer organization metadata is retrieved from a multi-tenant on-demand database system. In one embodiment, the customer organization metadata may include any metadata within the multi-tenant on-demand database system that is associated with one or more organizations of the customer (e.g., one or more customer accounts within the system, etc.).

Additionally, as shown in operation 204, a deviation of the metadata is determined from a current security configuration. In one embodiment, the current security configuration may include one or more default settings recommended by the system for optimal security within the system. In another embodiment, the customer may alter the current security configuration (e.g., by weighing one or more elements of the security configuration, etc.). Also, in one embodiment, the deviation may be determined utilizing one or more formulas. For example, the metadata may be compared against one or more elements of the security configuration utilizing a formula, and the formula may determine the deviation.

Further, as shown in operation 206, a security health summary is displayed to the customer, based on the deviation. In one embodiment, the security health summary may illustrate the deviation between the metadata and the current security configuration. In another embodiment, the security health summary may suggest one or more operations to be performed in order to better comply with the current security configuration.

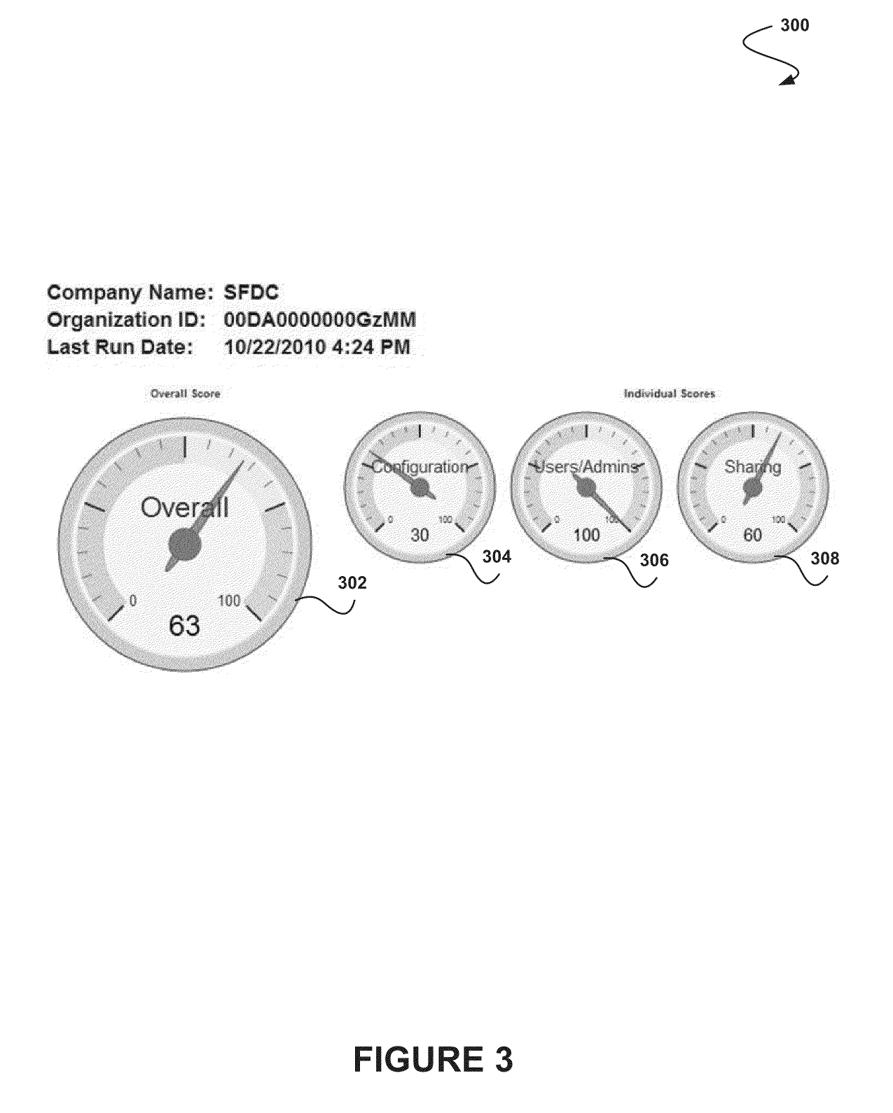

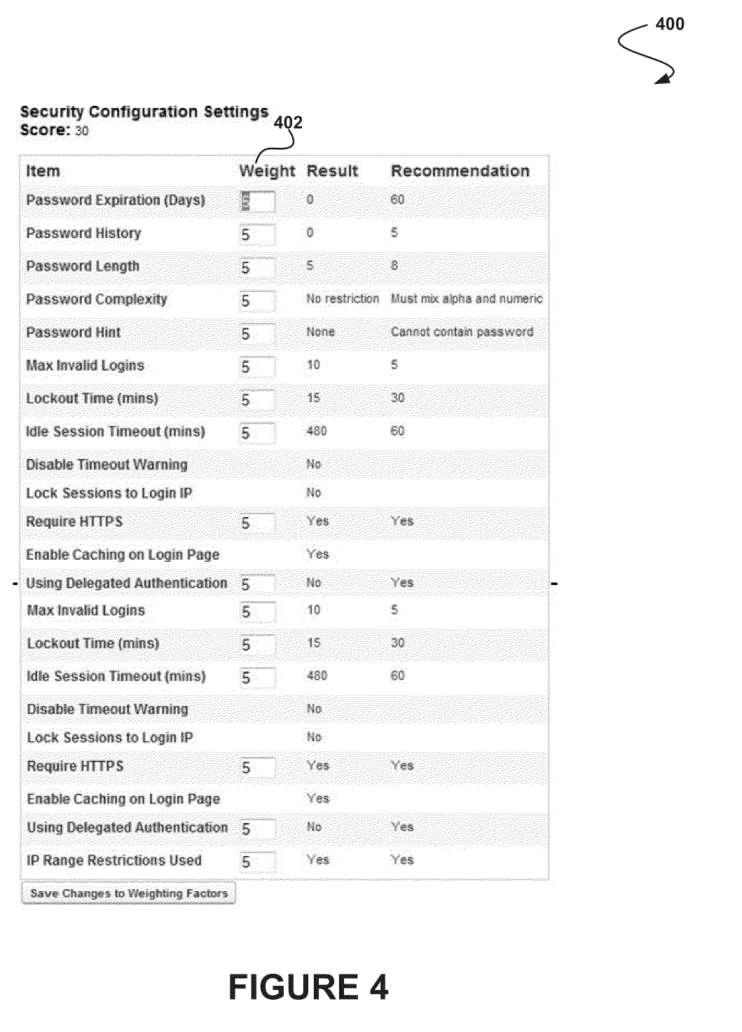

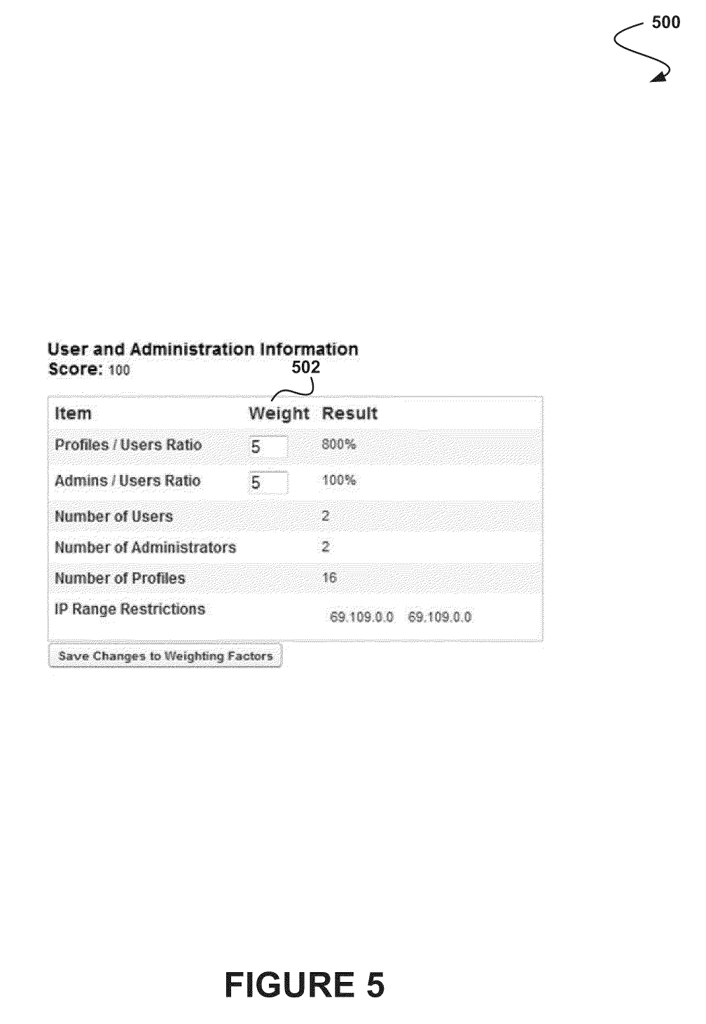

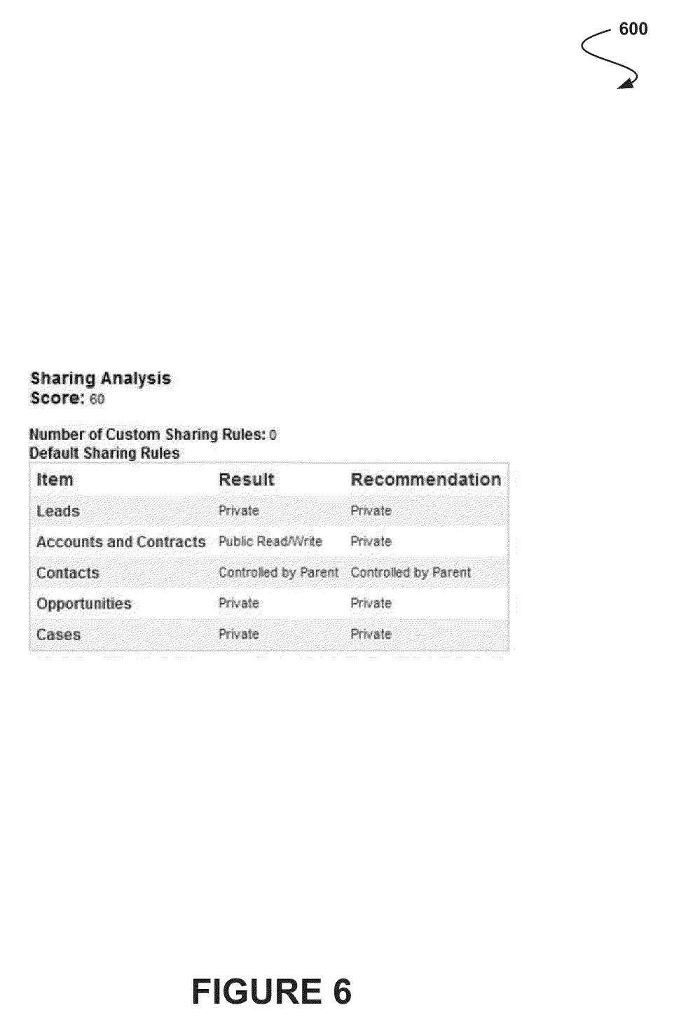

Further still, in one embodiment, the security health summary may be displayed utilizing one or more graphical illustrations. FIG. 3 illustrates an exemplary graphical health summary 300 that includes an overall graphical security score 302, a configuration security score 304, a user/administrator (e.g., ration of user to administrators, etc.) security score 306, and a sharing security score 308. In another embodiment, the settings used in the current security configuration may be weighted. For example, FIG. 4 illustrates an exemplary security configuration settings page 400 where details regarding specific settings are displayed and where the customer may adjust the weight 402 for one or more of the security configuration settings. Additionally, FIG. 5 illustrates an exemplary user and administration information page 500 where details regarding specific user and administration information are displayed and where the customer may adjust the weight 502 for one or more of the user and administration settings. Further, FIG. 6 illustrates an exemplary sharing analysis page 600 where details regarding specific sharing settings are displayed.

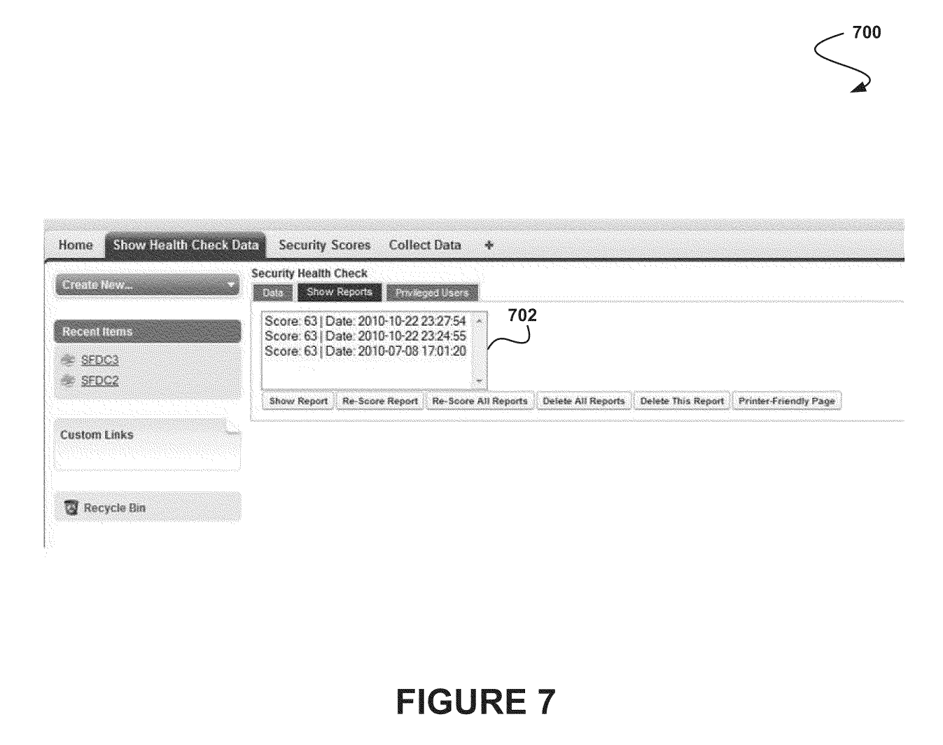

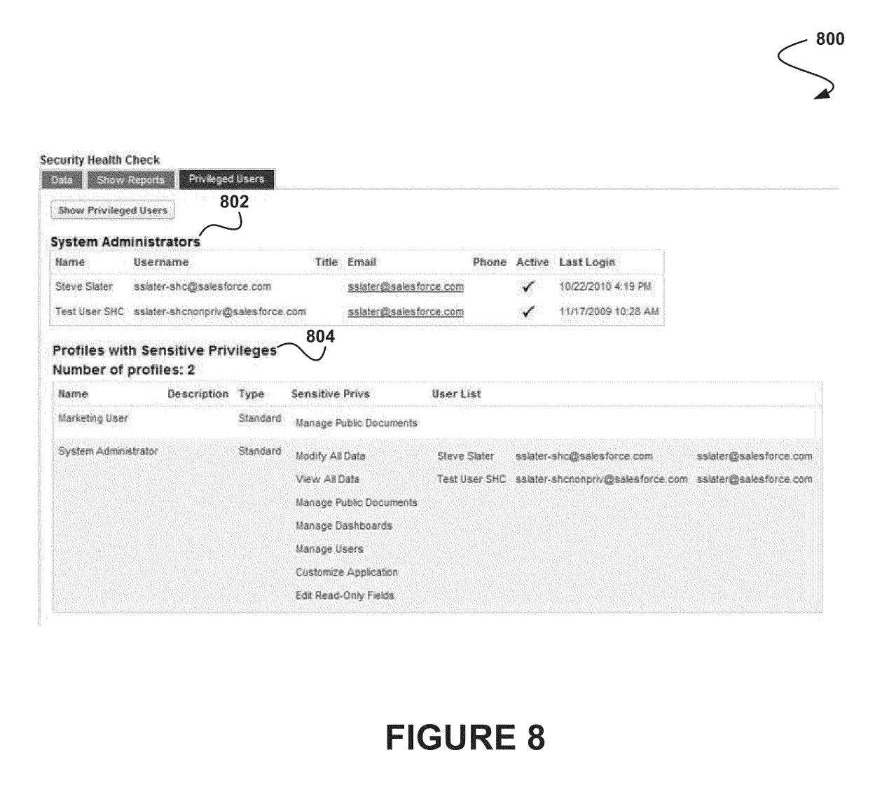

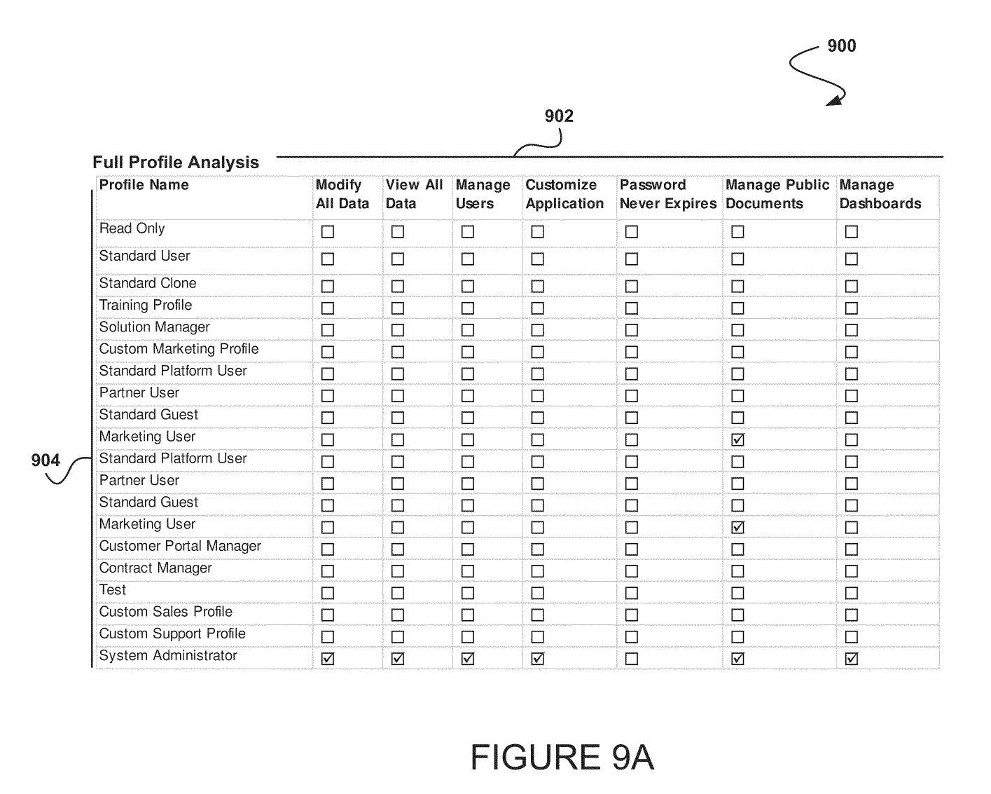

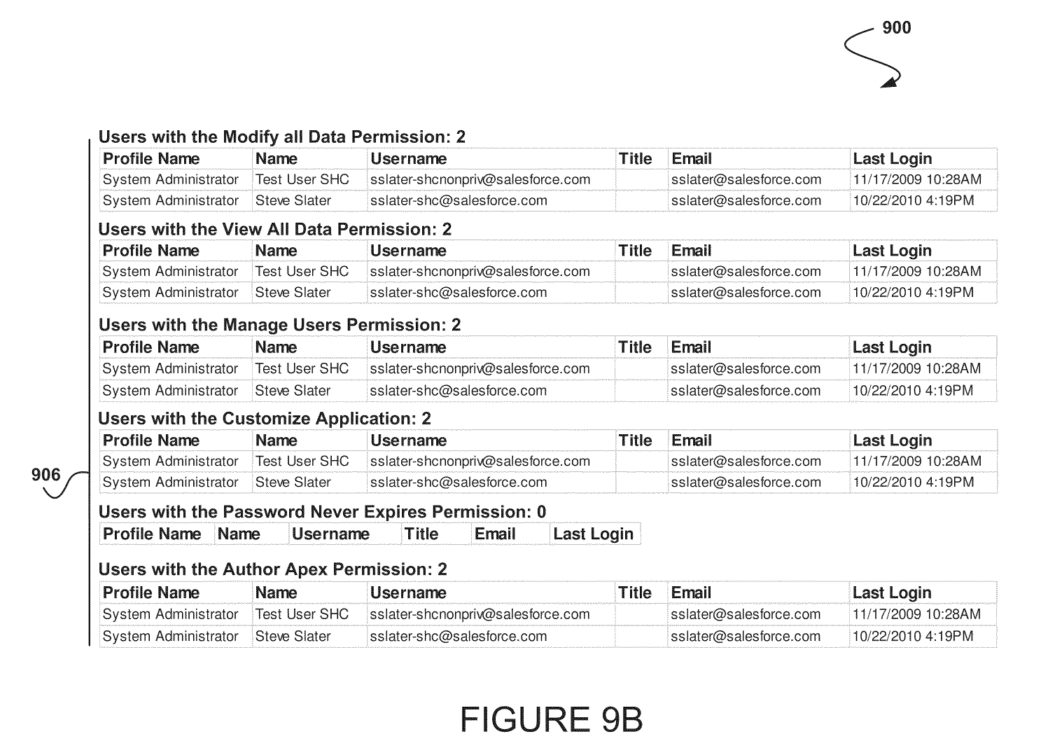

Also, in one embodiment, the security health summary may be saved and accessed at a later time. For example, FIG. 7 illustrates a saved security health check summary 700, where saved health summaries may be selected in window 702 in order to be retrieved. Additionally, in another embodiment, one or more details associated with the security health summary may be provided to the customer. For example, FIG. 8 illustrates a privileged users detail page 800, which provides details with respect to existing system administrators 802 and current profiles with sensitive privileges 804. Additionally, FIG. 9 illustrates a full profile analysis page 900, where multiple security settings 902 may be configured for each profile 904, and where more information regarding a status of each of security settings is found in the settings summary 906.

In this way, the security health summary application may perform a quick review of your security-related settings and make recommendations for improvement. The health summary may provide a numeric score and may track the customer's overall security posture over time. The security health summary may also note administrative users, review customer profiles and users to report on all users that have sensitive access rights, and review customer default and custom sharing rules. Additionally, the security health summary may check security-related settings and make recommendations for areas to improve customer security and limit data loss.

In another embodiment, the application may be live and a customer may be given a login so that they can see/use the application directly. Further, in another embodiment, the application may optionally do any of the following: scores your account for security in 3 categories; collect security-related configuration settings, where such settings may be related to password policies, session security, and IP restrictions; assign a numeric score to each setting, based on recommendations, where scores may range from 0-10, with zero being the worst (least-secure option) and 10 being the best (most-secure option). Further still, when multiple options are available, the difference may be averaged. Also, certain parameters may be all-or-nothing=0 or 10, and scores may be averaged across all values.

Additionally, in one embodiment, the customer (e.g., user, etc.) may modify the weights and may assign more or less relevance to a particular category. For example, a score may be assigned based on user and administration information. Additionally, a ratio of number of Profiles/Users may be considered. For example, profiles may be associated with a role of privileges. For instance, if a company has a high number of roles compared to the number of users, that may indicate that more users are custom and can imply a less secure configuration.

Further, in one embodiment, a ratio of administrators to users may be considered. For example, if a company has a high number of administrators relative to general users, that may indicate that possibly too many users have too high of privilege levels, which may lead to too many users that can see/change everything (may be less secure). Further still, scores sharing rules may be considered. For example, it may be desirable to give a summary to what sharing is within the system. Standard language may be provided within the system.

Also, in another embodiment, to ensure proper data privacy, a private sharing model may be used and number of exception sharing rules may be minimized. In addition, scores of 0-10 may be assigned for sharing settings based on 5 types of system data—leads, contacts, accounts, opportunities, and cases. The health check may calculate an overall score as the average of the above 3 sub-scores. Further, in one embodiment, scores may be saved which may allow a customer to track progress over time. Further still, in yet another embodiment, the customer may re-score their current and previous scores based on a change in weighting factors.

Also, in one embodiment, a report may be provided showing users and privileges. A system administration function may enable customers to assign privileges to a profile (like a role in other products), assign a profile to a user, etc. Further, the health check may show those items and may highlight/report on some of the more sensitive privileges to help the user identify areas of concern. In this way, the customer may focus their attention on users with more sensitive privileges. In yet another embodiment, the health check may show reports based upon: users that are system administrators and the last login time; which profiles contain some of the more sensitive privileges, such as managing public documents, modifying all data, viewing all data, managing dashboards, managing users, customizing application, editing read-only fields, etc. For each of those privileges, the health check may show reports of which users are assigned which privilege, and which profile gives them that privilege.

Additionally, in one embodiment, a plurality of security-related configuration settings may be retrieved as metadata for the customer organization. In one embodiment, default settings may form a baseline starting point for security, and additional measures may be implemented. In another embodiment, the security-related configuration settings may include password settings. For example, several settings may be used to place restrictions on active user sessions. These may include configuring the idle session timeout, locking sessions to the IP address used at login, and requiring secure (HTTPS) connections. Many of the default settings may be modified to improve security. In particular, note that the default idle session timeout value may be 2 hours and may be lowered for customers.

Further, in one embodiment, the security-related configuration settings may include login and authentication settings. For example, by default, all users may log in to the system from any IP address at any time of day, subject to the restrictions of the Identity Confirmation feature described below. A customer may restrict user login access to specific work hours and/or defined ranges of IP addresses. These restrictions may be defined based on one or more User Profiles.

Further still, in another embodiment, the security-related configuration settings may include time of day restrictions. For example, user logins may be restricted to specific times of the day. Different time-of-day restrictions may be defined for different types of users. In yet another embodiment, the security-related configuration settings may include IP address restrictions. For example, user logins may be restricted to specific IP addresses or ranges of IP addresses. IP range restrictions may be configured for the entire organization or for each particular class of user.

Also, in one embodiment, the security-related configuration settings may include single sign-on options. For example, in addition to the standard username and password authentication, the system may support two or more types of single sign-on methods. In another embodiment, the security-related configuration settings may include identity confirmation. In yet another embodiment, the security-related configuration settings may include data privacy. For example, data privacy, or access to your data, may be controlled by several features. On element of data privacy may be a user default sharing model, which may consist of the default settings that control access to standard and custom objects. These default settings may be extended with custom sharing rules, profile settings, and role hierarchies. In addition, users may place restrictions on individual fields on a particular record. In another embodiment, access to system data may be determined by a combination of profiles, field-level security, and sharing settings.

For example, a profile may be similar to a role in enterprise applications, except that each user may be required to have one profile and may not have more than one profile. Every profile may include one or more permissions that define what a user may do within the system, such as adding and removing users or creating custom fields and object types. In addition to detailed permissions, a profile may define the default access privileges to standard and custom objects, such as contacts, accounts, leads, opportunities, etc. In another embodiment, the system may define several default profiles, referred to as “standard profiles.” The available standard profiles may depend on the edition of the system in use, and the standard profiles may not be modified. Reviewing standard profiles for data privacy is relatively simple since only a system administrator profile may have full administrative access.

For larger companies, the system may define custom profiles (e.g., using a combination of a plurality of individual permissions, etc.). Since profiles may be the first step in determining data access rights, they may be reviewed closely. If custom profiles have been used, each profile may be examined to determine which privileges are included and which users have been assigned to the profile.

In another example, field-level security may provide granular control over specific fields related to system objects. For example, an email address may be a field of a contact object. In one embodiment, every field in every object may be assigned unique access privileges based on the user's profile. For example, the email address of a contact may be restricted to read-only for one profile, not visible for another profile, and fully editable by yet a third profile. Field-level security rules may be reviewed periodically since they may override other types of data access settings

Additionally, in yet another example, a default sharing model and sharing rules may be central to controlling access system data. The sharing settings may define the access rights to each system object. In summary, sharing permissions may be based on the default permissions (the sharing model) and exception rules (the sharing rules). It should also be noted that each object type (Account, Contact, Lead, etc.) may have independent sharing models and rules.

Further, in one embodiment, the customer may set up rules to define exceptions to the default sharing settings of most objects. In general, a sharing rule may consist of three components: the owner, the user with whom to share, and access permission. In another embodiment, a role in the system may be more closely tied to an organizational chart and each user may only be assigned to a single role. Roles may be used by the sharing settings to control access to records. In one embodiment, the role hierarchy may not be used because the default sharing settings are public read/write. Once more restrictive sharing settings are enabled (such as a private model) the roles and role hierarchies may be the primary criteria used to control data access.

In yet another embodiment, to use role-based sharing, an accurate organization-based role hierarchy may be defined and all users assigned to a role. A customer may create multiple unique roles for their organization, and the names of each role may be fully customizable. The default sharing rules may follow the role hierarchy and users higher in the hierarchy may automatically inherit the privileges of the subordinate roles. Further, in one embodiment, the default settings within the system may assign public read/write permissions to nearly all records, including leads, contacts, accounts, and custom objects. As a result, all users may have full access to every record. If different users require varying levels of data access, the system may recommend defining a role hierarchy that matches your company and specifying a private sharing model for sensitive object types. Restricting access to system data may require advance planning and testing and may involves the following steps: defining a role hierarchy and assigning a role to every user; modifying the organization-wide default sharing settings for sensitive object types by setting them to private; and defining sharing rules to provide role-based exceptions to the default settings.

Further, in one embodiment, the system may include an on-demand application-sharing service. For example, a customer may use the service to browse, install, and share apps and components stored in packages and built for the system platform. The customer may review apps submitted by other system customers, take a test drive, and install the apps. These apps may work just like other custom apps within the customer's system organization. In another embodiment, all applications may be checked for security flaws by the system. The system may review applications annually.

In another embodiment, the applications listed on the on-demand application-sharing service may be packaged in one of two ways—native or composite. Native applications may consist of only system entities such as custom objects, reports, workflows, Apex classes, or Visualforce pages. When native applications are installed, no data may be sent to a third-party site. Composite applications may include a combination of native features as well as connections to and/or from a third-party data center. The details vary with each application, but data may be typically shared between the system and the database of the company providing the application. The application may use the session ID of the currently authenticated user to make a web services connection to the system API. Because of the nature of this integration, composite applications may have the same access rights as the user currently logged in.

Further still, in another embodiment, the system application may provide several types of audit logs for monitoring logins and changes to a customer's system organization. All the audit features can be viewed by a system administrator, such as: user login history (all successful and failed login attempts may be recorded and saved for a predetermined time period); setup audit trail (every configuration (setup) change may be logged and archived for a predetermined time period; the setup audit trail may show any change and who made the change); and object history tracking (a customer may select certain standard and custom fields to track the change history; each time a user modifies one of the tracked fields, an entry may be added to the history related list on the object, showing the time, user, and the change made; by default, no specific fields may be tracked until activated by the administrator).

### System Overview

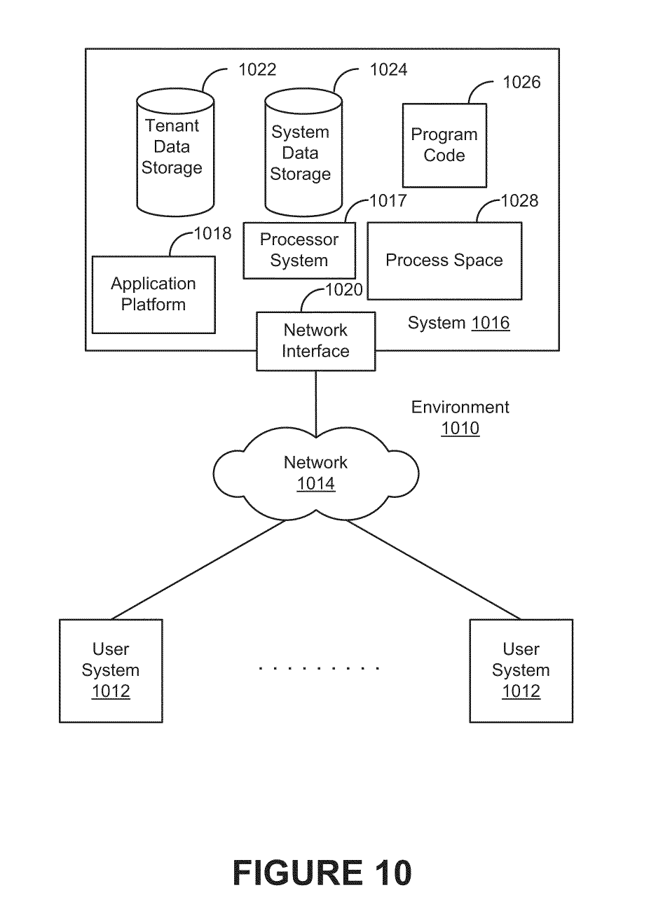

FIG. 10 illustrates a block diagram of an environment 1010 wherein an on-demand database system might be used. Environment 1010 may include user systems 1012, network 1014, system 1016, processor system 1017, application platform 1018, network interface 1020, tenant data storage 1022, system data storage 1024, program code 1026, and process space 1028. In other embodiments, environment 10 may not have all of the components listed and/or may have other elements instead of, or in addition to, those listed above.

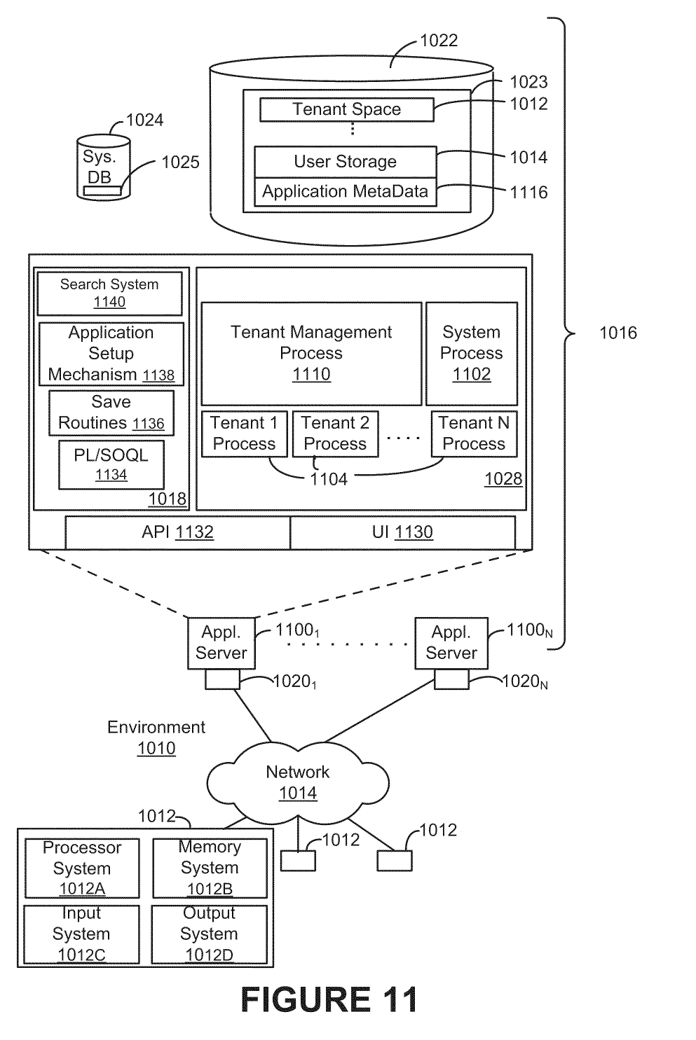

Environment 1010 is an environment in which an on-demand database system exists. User system 1012 may be any machine or system that is used by a user to access a database user system. For example, any of user systems 1012 can be a handheld computing device, a mobile phone, a laptop computer, a work station, and/or a network of computing devices. As illustrated in FIG. 10 (and in more detail in FIG. 11) user systems 1012 might interact via a network 1014 with an on-demand database system, which is system 1016.

An on-demand database system, such as system 1016, is a database system that is made available to outside users that do not need to necessarily be concerned with building and/or maintaining the database system, but instead may be available for their use when the users need the database system (e.g., on the demand of the users). Some on-demand database systems may store information from one or more tenants stored into tables of a common database image to form a multi-tenant database system (MTS). Accordingly, “on-demand database system 1016” and “system 1016” will be used interchangeably herein. A database image may include one or more database objects. A relational database management system (RDMS) or the equivalent may execute storage and retrieval of information against the database object(s). Application platform 1018 may be a framework that allows the applications of system 1016 to run, such as the hardware and/or software, e.g., the operating system. In an embodiment, on-demand database system 1016 may include an application platform 1018 that enables creation, managing and executing one or more applications developed by the provider of the on-demand database system, users accessing the on-demand database system via user systems 1012, or third party application developers accessing the on-demand database system via user systems 1012.

The users of user systems 1012 may differ in their respective capacities, and the capacity of a particular user system 1012 might be entirely determined by permissions (permission levels) for the current user. For example, where a salesperson is using a particular user system 1012 to interact with system 1016, that user system has the capacities allotted to that salesperson. However, while an administrator is using that user system to interact with system 1016, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 1014 is any network or combination of networks of devices that communicate with one another. For example, network 1014 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

User systems 1012 might communicate with system 1016 using TCP/IP and, at a higher network level, use other common Internet protocols to communicate, such as HTTP, FTP, AFS, WAP, etc. In an example where HTTP is used, user system 1012 might include an HTTP client commonly referred to as a “browser” for sending and receiving HTTP messages to and from an HTTP server at system 1016. Such an HTTP server might be implemented as the sole network interface between system 1016 and network 1014, but other techniques might be used as well or instead. In some implementations, the interface between system 1016 and network 1014 includes load sharing functionality, such as round-robin HTTP request distributors to balance loads and distribute incoming HTTP requests evenly over a plurality of servers. At least as for the users that are accessing that server, each of the plurality of servers has access to the MTS′ data; however, other alternative configurations may be used instead.

In one embodiment, system 1016, shown in FIG. 10, implements a web-based customer relationship management (CRM) system. For example, in one embodiment, system 1016 includes application servers configured to implement and execute CRM software applications as well as provide related data, code, forms, webpages and other information to and from user systems 1012 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 1016 implements applications other than, or in addition to, a CRM application. For example, system 1016 may provide tenant access to multiple hosted (standard and custom) applications, including a CRM application. User (or third party developer) applications, which may or may not include CRM, may be supported by the application platform 1018, which manages creation, storage of the applications into one or more database objects and executing of the applications in a virtual machine in the process space of the system 1016.

One arrangement for elements of system 1016 is shown in FIG. 10, including a network interface 1020, application platform 1018, tenant data storage 1022 for tenant data 1023, system data storage 1024 for system data 1025 accessible to system 1016 and possibly multiple tenants, program code 1026 for implementing various functions of system 1016, and a process space 1028 for executing MTS system processes and tenant-specific processes, such as running applications as part of an application hosting service. Additional processes that may execute on system 1016 include database indexing processes.

Several elements in the system shown in FIG. 10 include conventional, well-known elements that are explained only briefly here. For example, each user system 1012 could include a desktop personal computer, workstation, laptop, PDA, cell phone, or any wireless access protocol (WAP) enabled device or any other computing device capable of interfacing directly or indirectly to the Internet or other network connection. User system 1012 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 1012 to access, process and view information, pages and applications available to it from system 1016 over network 1014. Each user system 1012 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 1016 or other systems or servers. For example, the user interface device can be used to access data and applications hosted by system 1016, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 1012 and all of its components are operator configurable using applications, such as a browser, including computer code run using a central processing unit such as an Intel Pentium® processor or the like. Similarly, system 1016 (and additional instances of an MTS, where more than one is present) and all of their components might be operator configurable using application(s) including computer code to run using a central processing unit such as processor system 1017, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 1016 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known; or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, each system 1016 is configured to provide webpages, forms, applications, data and media content to user (client) systems 1012 to support the access by user systems 1012 as tenants of system 1016. As such, system 1016 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 11 also illustrates environment 1010. However, in FIG. 11 elements of system 1016 and various interconnections in an embodiment are further illustrated. FIG. 11 shows that user system 1012 may include processor system 1012A, memory system 1012B, input system 1012C, and output system 1012D. FIG. 11 shows network 1014 and system 1016. FIG. 11 also shows that system 1016 may include tenant data storage 1022, tenant data 1023, system data storage 1024, system data 1025, User Interface (UI) 1130, Application Program Interface (API) 1132, PL/SOQL 1134, save routines 1136, application setup mechanism 1138, applications servers 1100₁-1100_{N}, system process space 1102, tenant process spaces 1104, tenant management process space 1110, tenant storage area 1112, user storage 1114, and application metadata 1116. In other embodiments, environment 1010 may not have the same elements as those listed above and/or may have other elements instead of, or in addition to, those listed above.

User system 1012, network 1014, system 1016, tenant data storage 1022, and system data storage 1024 were discussed above in FIG. 10. Regarding user system 1012, processor system 1012A may be any combination of one or more processors. Memory system 1012B may be any combination of one or more memory devices, short term, and/or long term memory. Input system 1012C may be any combination of input devices, such as one or more keyboards, mice, trackballs, scanners, cameras, and/or interfaces to networks. Output system 1012D may be any combination of output devices, such as one or more monitors, printers, and/or interfaces to networks. As shown by FIG. 11, system 1016 may include a network interface 1020 (of FIG. 10) implemented as a set of HTTP application servers 1100, an application platform 1018, tenant data storage 1022, and system data storage 1024. Also shown is system process space 1102, including individual tenant process spaces 1104 and a tenant management process space 1110. Each application server 1100 may be configured to tenant data storage 1022 and the tenant data 1023 therein, and system data storage 1024 and the system data 1025 therein to serve requests of user systems 1012. The tenant data 1023 might be divided into individual tenant storage areas 1112, which can be either a physical arrangement and/or a logical arrangement of data. Within each tenant storage area 1112, user storage 1114 and application metadata 1116 might be similarly allocated for each user. For example, a copy of a user's most recently used (MRU) items might be stored to user storage 1114. Similarly, a copy of MRU items for an entire organization that is a tenant might be stored to tenant storage area 1112. A UI 1130 provides a user interface and an API 1132 provides an application programmer interface to system 1016 resident processes to users and/or developers at user systems 1012. The tenant data and the system data may be stored in various databases, such as one or more Oracle™ databases.

Application platform 1018 includes an application setup mechanism 1138 that supports application developers' creation and management of applications, which may be saved as metadata into tenant data storage 1022 by save routines 1136 for execution by subscribers as one or more tenant process spaces 1104 managed by tenant management process 1110 for example. Invocations to such applications may be coded using PL/SOQL 1134 that provides a programming language style interface extension to API 1132. A detailed description of some PL/SOQL language embodiments is discussed in commonly owned co-pending U.S. Provisional Patent Application 60/828,192 entitled, PROGRAMMING LANGUAGE METHOD AND SYSTEM FOR EXTENDING APIS TO EXECUTE IN CONJUNCTION WITH DATABASE APIS, by Craig Weissman, filed Oct. 4, 2006, which is incorporated in its entirety herein for all purposes. Invocations to applications may be detected by one or more system processes, which manages retrieving application metadata 1116 for the subscriber making the invocation and executing the metadata as an application in a virtual machine.

Each application server 1100 may be communicably coupled to database systems, e.g., having access to system data 1025 and tenant data 1023, via a different network connection. For example, one application server 1100₁ might be coupled via the network 1014 (e.g., the Internet), another application server 1100_{N-1} might be coupled via a direct network link, and another application server 1100_{N} might be coupled by yet a different network connection. Transfer Control Protocol and Internet Protocol (TCP/IP) are typical protocols for communicating between application servers 1100 and the database system. However, it will be apparent to one skilled in the art that other transport protocols may be used to optimize the system depending on the network interconnect used.

In certain embodiments, each application server 1100 is configured to handle requests for any user associated with any organization that is a tenant. Because it is desirable to be able to add and remove application servers from the server pool at any time for any reason, there is preferably no server affinity for a user and/or organization to a specific application server 1100. In one embodiment, therefore, an interface system implementing a load balancing function (e.g., an F5 Big-IP load balancer) is communicably coupled between the application servers 1100 and the user systems 1012 to distribute requests to the application servers 1100. In one embodiment, the load balancer uses a least connections algorithm to route user requests to the application servers 1100. Other examples of load balancing algorithms, such as round robin and observed response time, also can be used. For example, in certain embodiments, three consecutive requests from the same user could hit three different application servers 1100, and three requests from different users could hit the same application server 1100. In this manner, system 1016 is multi-tenant, wherein system 1016 handles storage of, and access to, different objects, data and applications across disparate users and organizations.

As an example of storage, one tenant might be a company that employs a sales force where each salesperson uses system 1016 to manage their sales process. Thus, a user might maintain contact data, leads data, customer follow-up data, performance data, goals and progress data, etc., all applicable to that user's personal sales process (e.g., in tenant data storage 1022). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 1016 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 1016 might also maintain system level data usable by multiple tenants or other data. Such system level data might include industry reports, news, postings, and the like that are sharable among tenants.

In certain embodiments, user systems 1012 (which may be client systems) communicate with application servers 1100 to request and update system-level and tenant-level data from system 1016 that may require sending one or more queries to tenant data storage 1022 and/or system data storage 1024. System 1016 (e.g., an application server 1100 in system 1016) automatically generates one or more SQL statements (e.g., one or more SQL queries) that are designed to access the desired information. System data storage 1024 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A computer program product embodied on a tangible computer readable medium, comprising:
computer code for retrieving data associated with a client of a multi-tenant on-demand database system;
computer code for comparing the data to one or more criteria; and
computer code for performing one or more actions, based on the comparing.

2. The computer program product of claim 1, wherein the client includes a customer of the multi-tenant on-demand database system.

3. The computer program product of claim 1, wherein the data associated with the client includes one or more items of metadata.

4. The computer program product of claim 1, wherein the data includes settings associated with a security configuration of the client on the system.

5. The computer program product of claim 1, wherein the data includes one or more of password settings, session settings, login settings, authorization settings, and sharing settings.

6. The computer program product of claim 1, wherein the data associated with the client illustrates a current configuration of the client within the multi-tenant on-demand database system.

7. The computer program product of claim 1, wherein the criteria include a predetermined configuration for the client on the system.

8. The computer program product of claim 1, wherein the criteria include security best practices that are determined for the client by the system.

9. The computer program product of claim 1, wherein the computer program product is operable such that comparing the data to one or more criteria includes determining a deviation of the data from the one or more criteria.

10. The computer program product of claim 1, wherein the computer program product is operable such that the comparison is performed using an algorithm.

11. The computer program product of claim 1, wherein the computer program product is operable such that one or more elements of the data are weighted.

12. The computer program product of claim 11, wherein the computer program product is operable such that elements of the data that are determined to be more/less important than other elements are weighted more/less heavily than those elements during the comparing, respectively.

13. The computer program product of claim 1, wherein the computer program product is operable such that comparing the data to the one or more criteria is performed according to a template.

14. The computer program product of claim 13, wherein the computer program product is operable such that multiple templates are provided, and the client or an administrator determines which template is to be used during the comparing.

15. The computer program product of claim 1, wherein the computer program product is operable such that the results of the comparing are presented to the client of the multi-tenant on-demand database system.

16. The computer program product of claim 1, wherein the computer program product is operable such that an overall summary is output to the client that illustrates the differences between the retrieved data and the one or more criteria.

17. The computer program product of claim 1, wherein the computer program product is operable such that recommendations are provided to the client as to how to adjust or otherwise alter the data associated with the client in order to better comply with the one or more criteria, based on the comparing.

18. The computer program product of claim 1, wherein the computer program product is operable such that the client is able to adjust one or more criteria, based on the comparing.

19. A method, comprising:
retrieving data associated with a client of a multi-tenant on-demand database system;
comparing the data to one or more criteria; and
performing one or more actions, based on the comparing.

20. An apparatus, comprising:
a processor for:
retrieving data associated with a client of a multi-tenant on-demand database system;
comparing the data to one or more criteria; and
performing one or more actions, based on the comparing.

21. A method for transmitting code for use in a multi-tenant database system on a transmission medium, the method comprising:
transmitting code for retrieving data associated with a client of a multi-tenant on-demand database system;
transmitting code for comparing the data to one or more criteria; and
transmitting code for performing one or more actions, based on the comparing.
